(19) United States
(12) Patent Application Publication
(10) Pub. No.: US 2002/0152099 A1
(43) Pub. Date: Oct. 17, 2002

(54) Process for providing a single business network of owners of independent commercial office buildings

(76) Inventors: Oliver T. Carr JR., Bethesda, MD (US); Oliver T. Carr III, Potomac, MD (US)

Correspondence Address: Jennifer A. Albert, Esq., Hunton & Williams, Suite 1200, 1900 K Street, N.W., Washington, DC, 20006, US

(21) Appl. No.: 09/832,956

(22) Filed: Apr. 12, 2001

(51) Int. Cl. G06F 17/60

(52) U.S. Cl. 705/5; 709/203

(57) ABSTRACT

A process of providing a single business network including a plurality of member entities wherein each of the plurality of member entities is an owner/manager of at least one independently owned commercial office building. The process comprises the steps of aggregating the plurality of independently owned commercial office buildings under a single brand identity; marketing the plurality of independently-owned commercial office buildings on a regional and a nationwide basis under the single brand identity; negotiating discounted prices for purchase of goods and services on behalf of the aggregated plurality of independently owned commercial office buildings; providing a Tenant Services program for the plurality of tenants of the independently-owned commercial office buildings which Tenant Services Program offers a variety of goods and services to the tenants that they may desire to purchase; and implementing an online leasing/reservation system to list space available for lease in the aggregated plurality of independently owned commercial office buildings and to facilitate leasing transactions.

### BACKGROUND OF THE INVENTION

Currently, it is estimated that independently owned and operated commercial office buildings make up approximately thirty to forty percent of the overall commercial office building market in the United States. For definitional purposes herein, “independent owners” are considered to be individuals and/or firms engaged in owning and managing/operating commercial real estate, and that own or control a portfolio of buildings totaling less than five million square feet in the aggregate. An entity will be considered to be an “owner” of real estate when title to such real estate is in the name of the respective individual/firm. Traditionally, the owners and/or managers of these independently owned and operated commercial office buildings have not been as efficient in renting space and/or maintaining costs in their office buildings as have large institutional entities that own and/or operate large portfolios of commercial office buildings and are therefore at a competitive disadvantage versus such large institutional entities. For the purposes herein, the term “institutional owners” shall refer to any entity owning and/or controlling in excess of five million square feet of commercial office buildings in the aggregate and shall include but not be limited to real estate investment trusts, pension funds, life insurance companies and other various entities owning/controlling such amounts of office buildings.

Additionally, the institutional owners often are able to offer their tenants a higher level of amenities than are typically offered by independent owners. Thus, tenants renting space in independently owned and operated commercial office buildings typically do not enjoy an equal level of amenities as tenants who rent space in a commercial office building of an owner/manager that manages multiple commercial office buildings. Sometimes these extra amenities and services in a commercial office building generate non-leasing revenues for the owner/manager of the commercial office building. So, the owner/manager benefits as well as the tenant from such extra amenities. Therefore, an independent owner/manager of a commercial office building may be at a competitive disadvantage by virtue of not being able to provide such amenities.

Another disadvantage experienced by an independent owner/manager of a commercial office building is that an owner/manager that manages multiple commercial office buildings may have more bargaining leverage to obtain more or better services or amenities from third-party vendors than the independent owner/manager of a commercial office building. Or, owners/managers having multiple commercial office building holdings may leverage such multiple commercial office building holdings to negotiate more competitive prices for goods and/or services from third-party vendors.

Moreover, an owner/manager that manages a large portfolio of commercial office buildings may have an advantage over an independent owner/manager in marketing and renting space in its commercial office buildings to potential tenants because of a higher level of “brand name recognition” in the marketplace, either among the leasing brokerage community or with individual tenants.

Owners/managers of multiple commercial office buildings may also be better equipped to invest in enhanced technology or other infrastructure-related equipment in order to operate and maintain their buildings at a high technical level. Independent owners/managers of commercial office buildings may lack the economies of scale and the capital to provide such improvements, thereby causing their buildings to be less technologically advanced.

Because of these factors, it is estimated that commercial office buildings that are institutionally owned experience operating profits up to 10% higher than comparable buildings that are independently owned.

For all of the above reasons, as well as others, owners/managers of single or independent commercial office buildings are at a competitive disadvantage to institutional owners/managers or owners/managers holding multiple commercial office building properties. Such owners/managers of single or independent commercial office buildings therefore have a need for a vehicle that will enable them to compete more effectively against institutional owners/managers or owners/managers holding multiple commercial office building properties.

### SUMMARY OF THE INVENTION

It is therefore an object of the present invention to overcome the above-mentioned drawbacks and others and to provide a vehicle that will enable owners/managers of single or independent commercial office buildings to compete more effectively against institutional owners/managers or owners/managers holding multiple commercial office building properties.

These and other objects are particularly achieved by a process for providing a single business network including a plurality of member entities, each one of the plurality of member entities being an owner/manager of at least one independently owned commercial office building in accordance with the embodiments of the present invention. The process comprises the steps of aggregating the plurality of independently owned commercial office buildings under a single brand identity; marketing the plurality of independently owned commercial office buildings on a regional and a nationwide basis under the single brand identity; negotiating discounted prices for purchase of goods and services on behalf of the aggregated plurality of independently owned commercial office buildings and a plurality of tenants of each of the member entities; negotiating one or more revenue sharing opportunities on behalf of the aggregated plurality of independently owned commercial office buildings from vendors seeking to advertise or display products or services on the commercial office building premises, or to gain access to the commercial office building premises to install equipment that may be used in marketing and selling products or services to the tenants of each of the member entities; implementing an online listing and reservation system to market space available for lease in the aggregated plurality of independently owned commercial office buildings and to facilitate leasing transactions; and implementing an online e-marketplace transaction platform where a plurality of the member entities can solicit bids for certain goods and services from one or more vendors for use at their commercial office building premises.

In another aspect, the invention comprises a process for enrolling a member entity in a business network including a plurality of member entities wherein each member entity owns/operates at least one commercial office building. The process comprises the steps of identifying a potential member of the business network through at least one of a referral by an existing member entity, a referral from a third-party vendor, a physical inspection of a particular market or submarket to identify one or more qualified commercial office buildings, and a review of a real estate database including a plurality of commercial office space listings; meeting with the potential member entity of the business network after the step of identifying the potential member entity of the business network in order to give a presentation to the potential member entity concerning the benefits of affiliation with the business network; and presenting a participation agreement to the potential member entity for execution by the potential member entity if the potential member entity agrees to become a member entity of the business network.

The accompanying drawings, which are incorporated in and constitute a part of this specification, illustrate embodiments of the invention and, together with the description, serve to explain the principles of the invention.

### BRIEF DESCRIPTION OF THE DRAWINGS

FIG. 1 is a flow chart illustrating the steps included in a process for providing a single business network including as members a plurality of owners/managers of at least one independently owned commercial office building in accordance with an embodiment of the invention;

FIG. 2 is a flow chart illustrating the steps included in a process for enrolling a member entity in a business network including a plurality of member entities wherein each member entity owns/operates at least one commercial office building in accordance with an embodiment of the present invention; and

FIG. 3 is a flow chart illustrating the steps included in a process for implementing a purchasing program for a business network in accordance with an embodiment of the present invention.

### DETAILED DESCRIPTION OF THE PREFERRED EMBODIMENTS

Reference will now be made in detail to the present preferred embodiments of the invention, examples of which are illustrated in the accompanying drawings in which like reference characters refer to corresponding elements.

The embodiments of the processes and systems of the present invention described herein provide for a national franchise of member entities of independently owned/operated commercial office building properties under a single brand identity to enable such member entities to compete more effectively with large, institutional owners and managers having multiple commercial office building properties.

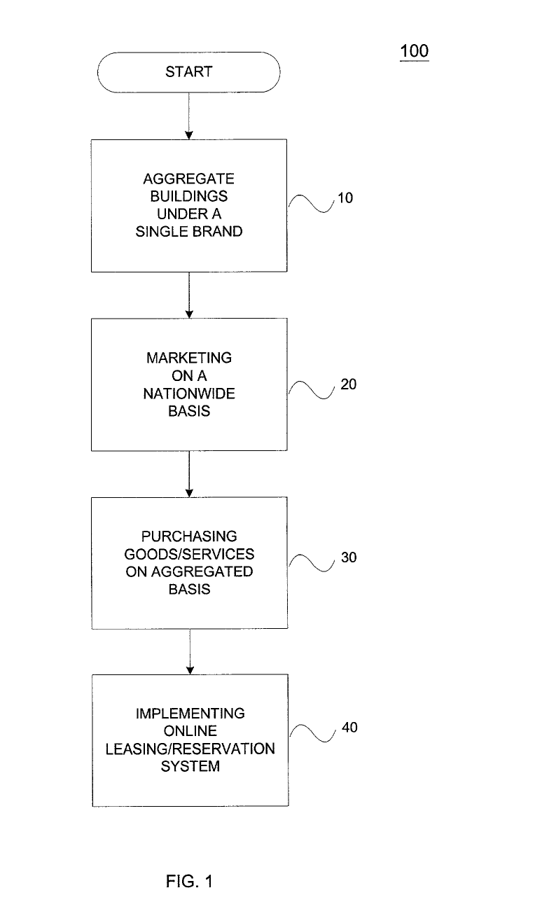

FIG. 1 is a flow chart illustrating a plurality of steps performed in a process 100 for providing a single business network including a plurality of member entities, wherein each one of the plurality of member entities is an independent owner or a manager of at least one commercial office building or property. The process 100 begins at step 10 by aggregating a plurality of independently owned/operated commercial office buildings under a single brand identity. For purposes of illustration only, assume that the single brand identity is the name “ACME Office Corporation” or ACME Office.

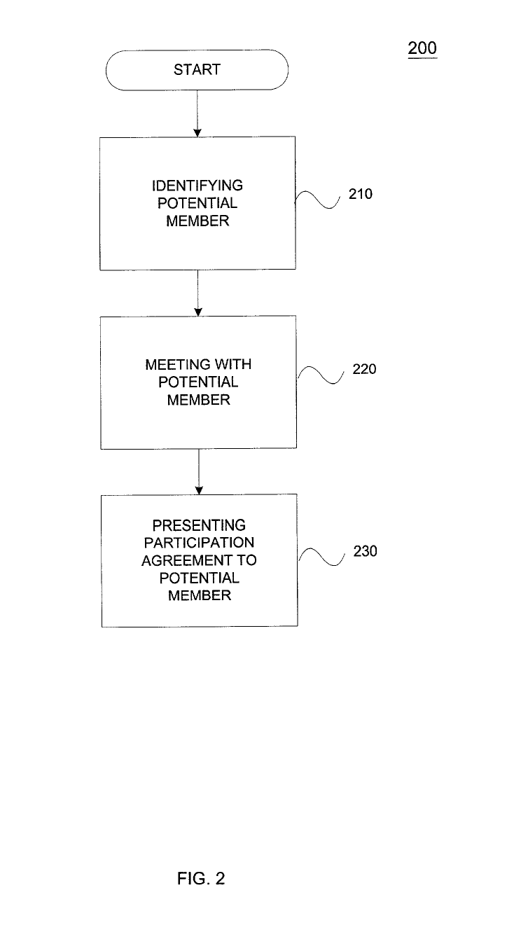

In order to aggregate the plurality of commercial office buildings, however, ACME Office must first enroll one or more member entities or franchisees to become affiliated with the single business network being formed by Preferred Offices. Such an enrollment process is illustrated in FIG. 2.

FIG. 2 is a flow chart illustrating a plurality of steps performed in a process 200 for enrolling a member entity in the ACME Office business network. A target potential member entity will own or operate at least one commercial office building. The commercial office building owned/operated by the target potential member will be a high-quality, well-run commercial office building (i.e., a commercial office building having Class A or Class B office inventory). Each of the plurality of member entities' commercial office buildings may vary considerably, however, from the commercial office buildings of the other member entities in terms of architectural design and amenities and other features.

As shown in FIG. 2, the process 200 begins at step 210 wherein a potential member entity of the ACME Office business network is identified. One or more of a plurality of means for identifying a potential member entity may be used including, but not limited to, a referral from a professional contact, a referral from an existing member entity of the ACME Office business network, a referral from a vendor of goods and/or services to the ACME Office business network, a physical survey of a particular office market where a prospective qualified commercial office building for inclusion in the network is identified, or a review of one or more real estate databases including a plurality of commercial office space listings.

Once a potential member entity has been identified, at step 220, a representative of the ACME Office business network may schedule a meeting with the potential member entity in order to give a presentation to the potential member entity concerning the benefits of affiliation with the ACME Office business network. Marketing and promotional materials about the ACME Office business network may be provided to the potential member entity at this meeting. Following the presentation, but during the course of the meeting, at step 230, a participation agreement may be presented to the potential member entity. The participation agreement includes a plurality of terms and conditions (discussed in greater detail below) which would apply to a relationship between the ACME Office business network and the potential member entity if the potential member entity agrees to become a member entity of the ACME Office business network. Alternatively, if the potential member entity is not able to make a decision concerning membership in the ACME Office business network, an additional one or more follow-up meetings may be scheduled as necessary to answer any questions the potential member entity may have.

Following enrollment of a plurality of member entities, the plurality of commercial office buildings owned/managed by the plurality of member entities may be aggregated to form the ACME Office business network, as shown in step 10 of the process 100 illustrated in FIG. 1.

The next step, step 20, in the process 100 of FIG. 1 is the initiation and implementation of regional marketing campaigns for the plurality of independently owned commercial office buildings under the ACME Office single brand identity. These marketing campaigns will be conducted within a metropolitan area where a plurality of member entities are located. The regional marketing campaigns conducted in step may include one or more sub-steps including placing advertisements in a plurality of industry publications such as The Wall Street Journal, local and regional newspapers, including various real estate trade publications, as well as billboard and/or banner advertisements in public spaces, advertisements on the sides of municipal buses, etc. These advertisements may describe a plurality of benefits a potential tenant may realize through leasing office space in one of the commercial office buildings of one of the member entities of the ACME Office business network. The regional marketing campaigns may also include launching an Internet web site accessible to a plurality of potential tenants of commercial office space. The Internet web site may include content describing a plurality of benefits that a potential tenant may realize through leasing office space in one of the commercial office buildings of one of the members of the ACME Office business network. Other means may also be used for the regional marketing campaigns, such as radio and television advertising, among others. Once ACME Office has determined the membership base of its office network is of a sufficient size, national marketing campaigns may be initiated and implemented in addition to the regional marketing campaigns.

The next step in the process 100 is step 30 which entails negotiating discounted prices for the purchase of goods and services on behalf of the aggregated plurality of independently owned commercial office buildings and a plurality of tenants of each of the member entities. Step 30 may be referred to as implementation of a “Power Buying Program.” Once a new member entity has executed a participation agreement (following step 230 of process 200 of FIG. 2), the new member entity will be assessed an annual membership fee, which may be determined based on the total square footage of the new member entity's office buildings that are being enrolled in the ACME Office business network and the new member entity's “controllable” expenses associated with management of the office buildings. This fee may be invoiced to the member on a monthly basis by building. Typically, the amount of the membership fee should be less than the cost savings a member entity realizes through participation in the Power Buying Program and the various other tangible and intangible benefits derived through participation in the ACME Office business network. The new member entity's “controllable” expenses are comprised of all of the new member entity's operating expenses associated with the management of the new member entity's commercial office buildings less an amount equal to a total of real estate taxes assessed/paid on the new member entity's commercial office buildings plus property management fees paid in connection with the new member entity's commercial office buildings. Commercial office building expenses may vary from office building to office building and regional market to regional market, however, in a typical case, real estate taxes (not a controllable expense) approximate thirty-five percent (35%) of the total operating expenses, utilities expenses (controllable) approximate twenty-five percent (25%) of the total operating expenses, janitorial expenses (controllable) approximate twelve percent (12%) of the total operating expenses, repairs and maintenance costs associated with electrical systems and other equipment (controllable) approximate ten percent (10%) of the total operating expenses, salaries and wages (controllable) approximate eight percent (8%) of the total operating expenses, security services (controllable) approximate five percent (5%) of the total operating expenses, building management services (controllable) approximate four percent (4%) of the total operating expenses and insurance costs (controllable) approximate one percent (1%) of the total operating expenses. A new member entity's controllable expenses typically represent approximately fifty percent (50%) of the new member entity's total operating expenses associated with the management of the new member entity's commercial office buildings.

In exchange for the annual membership fee, the new member entity may participate in the ACME Office Power Buying Program, among other programs offered through the network. The Power Buying Program is designed to enable the member entities of the ACME Office business network to save money on operating expenses associated with the purchase of goods and services needed for operation of their commercial office buildings.

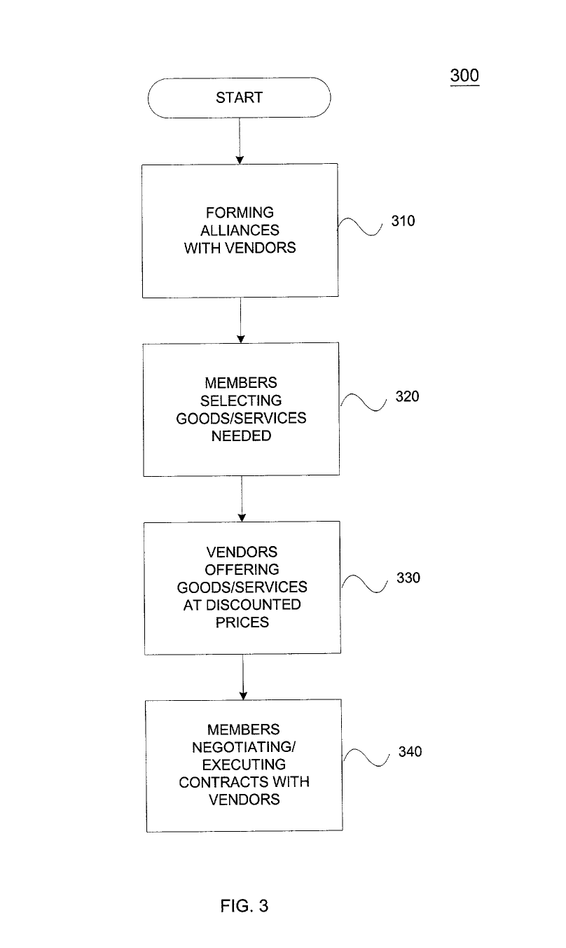

In order to implement the Power Buying Program, the ACME Office business network and the member entities engage in a process 300, the steps of which are illustrated in the flow chart shown in FIG. 3. The process 300 begins at step 310 where the ACME Office business network forms an alliance with each one of a plurality of vendors that offers for purchase goods and/or services required for operation of a commercial office building. Typical goods and/or services that would be used by owners/managers of commercial office buildings include, for example, janitorial goods and services; maintenance services for equipment such as heating/ventilation/air conditioning equipment, elevator equipment, telecommunications equipment and computer hardware and network equipment; landscaping goods and services; security services; building management services; office supplies; office furniture and travel-related services, for example. Each one of the plurality of vendors with whom alliances are formed should be selected based upon its reputation for providing high quality goods/services. The incentive for the vendors to participate in the Power Buying Program is an opportunity to market their goods/services to all of the member entities of the ACME Office business network without having to incur a substantial investment in marketing efforts. Each one of the vendors will be a “preferred provider” for its particular goods/services in a particular geographic market. However, each of the member entities is free to select another vendor outside of the preferred vendors for the Power Buying Program.

As part of the Power Buying program, ACME Office may also align with a vendor that operates a Business-to-Business (“B2B”) online marketplace that provides an e-commerce solution for the procurement of goods and services by real estate operators and managers within the ACME Office business network. This platform would enable members of ACME Office to procure products and services through competitive bidding events as well as auctions facilitated through the Internet. Such a marketplace would allow a property manager or real estate operator to post requests-for-proposals (“RFP”) for such things as roofing, heating/air-conditioning services, and tenant construction buildout. Multiple contractors interested in obtaining business from the participating members of the ACME Office network would compete online for the business by submitting bids. Online product catalogs could also be created through competitive bidding events with particular products and terms dictated by the members of the ACME Office business network. Suppliers and manufacturers can also hold “inventory auctions” by creating competitive bidding events for excess inventory that they may have.

Once the ACME Office business network selects a vendor and negotiates the terms and conditions of an alliance agreement with such vendor, the ACME Office business network will then execute an alliance agreement with the preferred vendor. Each of the alliance agreements will include a termination for convenience provision permitting the ACME Office business network to terminate the alliance agreement at any time and for any reason. Such a termination for convenience provision provides further incentive for each of the preferred vendors to continue to provide its goods/services at discounted prices to the member entities and to provide the goods and/or render the services in a consistently high quality manner or face the prospect of termination. Each alliance agreement will also include a provision wherein the vendor agrees to pay the ACME Office business network an annual marketing fee. The annual marketing fee is calculated as a percentage of a total of gross revenues the vendor realizes on all of the vendor's contracts with member entities. The annual marketing fee increases as the totals of gross revenues reach predetermined plateaus, which will vary depending upon the particular goods or services the vendor provides to the member entities.

Following the formation of alliance agreements with the plurality of vendors in step 310, at step 320, each member entity may select needed goods/services available for purchase from any one or more of the plurality of vendors. Because each member entity is free to deal or not deal with the preferred vendors at step 330, the vendors will likely offer their goods/services at discounted prices to the member entities in order to retain more member entities as customers. At step 340, each member entity will negotiate specific terms and conditions for an agreement with each one of the plurality of vendors from which the member entity desires to purchase goods or services. A plurality of factors may affect the specific terms and conditions of an agreement between a member entity and a vendor including, for example, a size of a commercial office building of the member entity, a geographic location of a commercial office building (e.g., services may be more expensive in a major metropolitan area such as New York City, for example, than in a less dense location such as Peoria, Ill.), and a level of service desired by the member entity. Additionally, each of the contracts between a member entity and one of the vendors should include a provision wherein the contract is automatically terminated if the alliance agreement between the ACME Office business network and the vendor is terminated, as well as a provision wherein the contract is automatically terminated if the member entity ceases to be a member entity of the ACME Office business network. In the event the member entity ceases to be a member entity of the ACME Office business network, the member entity and the vendor remain free to form their own contract, but such contract will no longer fall within the umbrella of an alliance agreement between the vendor and the ACME Office business network.

In addition to the Power Buying Program, the ACME Office business network will also offer the member entities a “Tenant Services Program” associated with third-party vendors with whom the ACME Office business network forms alliances. Specifically, some of the vendors with whom alliances are formed offer goods and/or services that are purchased by tenants of the member entities' commercial office buildings. For example, there may be an alliance agreement with a restaurant owner vendor, a travel agent vendor, an overnight courier service vendor, an online concierge service, and a sports club vendor, among others. The particular goods and/or services desired by tenants of the member entities' commercial office buildings will be determined, in part, by surveying the tenants. The intent, however, is that the ACME Office business network will form alliances with vendors that provide goods or services that are commonly desired by the tenants of as many member entities' commercial office buildings as possible in a particular geographic location (e.g., overnight courier, office supplies, office furniture, travel services). The incentive for the vendors to participate in the Tenant Services Program is that the vendors can reach many potential customers (i.e., employees of many tenants of many commercial office buildings) without being required to spend a high amount of marketing and promotional costs to reach such potential customers. Again, these vendors will be required to pay the ACME Office business network the annual marketing fee as described above, although in some cases, the ACME Office business network may decide to forgo any incentive fee to ensure a vendor's participation in the program.

In addition to the goods and services offered for sale to the ACME Office business network's tenants, the Tenant Services program would offer a Tenant Services Request tool to facilitate communication between a tenant and a property management company of the tenant's office building. This communication tool would be available through the ACME Office Web site and would be based on a email distribution system. Tenants in a particular office building could logon to the Tenant Services page of the ACME Office Web site and make a request for service within their suite (e.g., change a lightbulb) by sending an email, which would then be forwarded to that particular tenant's property management company.

The total revenues generated by the total of all of the annual marketing fees paid by all of the vendors participating in the Tenant Services program are then allocated among the member entities of the ACME Office business network, thereby creating a revenue enhancement opportunity for the member entities.

The Power Buying Program and the Revenue Enhancement Program not only may enable the member entities to cut operating costs and earn incremental revenues, but also may benefit the member entities by providing desired goods and services and other amenities to their tenants (some of which the member entities may not have been able to provide on their own outside of the Power Buying Program of the ACME Office business network), and may enable the member entities to realize increased occupancy rates in their commercial office buildings and resultant increased revenues relating to rentals.

In addition to the Power Buying Program, and the Tenant Services Program, the ACME Office Corporation business network will also offer the member entities a “Revenue Enhancement Program” associated with third-party vendors with whom the ACME Office business network forms alliances. Specifically, some of the vendors with whom alliances are formed offer goods and/or services that may be utilized by the member entities. These vendors will be required to pay the ACME Office business network annual marketing fees or other associated revenues. The intent of each revenue sharing alliance opportunity is to negotiate a more favorable revenue stream from the vendor for the office building compared to what the individual member entity would be able to negotiate with that vendor without the benefit of the ACME Office business network. Examples of the types of revenue enhancement opportunities that ACME Office would enter into include advertising and distribution channel alliances, as well as “access” revenues (e.g., telecommunication companies that wish to gain access to office buildings for the purpose of installing fiber optic equipment and lines in order to service the buildings' tenant bases would compensate the building owner in some fashion). Each alliance negotiated by ACME Office for the benefit of its plurality of member entities typically would include an allocation of some portion of the revenues generated by the vendor from each participating member entity's office buildings to ACME Office.

Referring back to FIG. 1, the final step in the process 100 of providing the ACME Office business network, step 40, entails the ACME Office business network implementing an online listing and reservation system to list space available for lease in the aggregated plurality of commercial office buildings of the member entities. Such an online listing and reservation system will enable the member entities to market space available for lease in their commercial office buildings in an efficient and low-cost manner to a large audience of potential tenants. The online listing and reservation system may be accessible to potential tenants via the Internet. The potential tenants may also benefit from such an online listing and reservation system in that the potential tenants may review information about available commercial office space without having to hire a licensed tenant representative broker and therefore may directly contact commercial office building owners or managers and save brokerage fees typically paid to such tenant representatives. The costs associated with the online listing exchange shall be paid by ACME Office Corporation and as such are included in the members' annual membership fee.

The online listing and reservation system is comprised of a data source including a listing for each one of the commercial office buildings owned/managed by each one of the member entities. Each of the listings includes a location for each one of the commercial office buildings, an age of each one of the commercial office buildings, and one or more units of office space available for leasing in each one of the commercial office buildings. Each of the listings further includes a rental price for each of the one or more units of office space available in each one of the commercial office buildings, a square footage amount for each of the one or more units of office space available, and one or more amenities associated with each of the one or more units of office space available. The online listing and reservation system also includes a search/retrieval engine for a potential tenant to use for querying the data source containing the office space listings based upon one or more input parameters (such as, for example, square footage required, location desired, etc.), and for selectively retrieving at least one listing of one or more units of office space available for leasing corresponding to the input parameters.

The online listing and reservation system further includes a reservation engine for enabling a potential tenant to contact a member entity that owns/manages a commercial office building that contains the one or more units of office space available for leasing which correspond to the potential tenant's desired input parameters in order that the potential tenant may reserve the office space and/or negotiate a lease for the office space with the member entity.

As is evident from the above description of the embodiments of the processes of the present invention, the invention enables independent owners/managers of commercial office buildings to compete more effectively against large institutional owners/managers and/or owners/managers of multiple commercial office buildings by providing a nationally marketed single brand name identity for the commercial office buildings of such independent owners/managers, discounted prices on goods/services of third-party vendors which are required for operation of the commercial office buildings, revenue enhancement opportunities in connection with goods/services of third-party vendors which are desired by tenants of the commercial office buildings and an efficient marketing vehicle for listing office space available for leasing in the commercial office buildings in the nature of the online listing and reservation system.

It will be apparent to those skilled in the art that various modifications and variations can be made in the processes of the present invention without departing from the scope or spirit of the invention. Thus, it is intended that the present invention cover the modifications and variations of this invention provided they come within the scope of the appended claims and their equivalents.

What is claimed is:

1. A process for providing a single business network including a plurality of member entities, each one of the plurality of member entities being an owner/manager of at least one independently owned commercial office building, the process comprising the steps of:
(a) aggregating the plurality of independently owned commercial office buildings under a single brand identity;
(b) marketing the plurality of independently owned commercial office buildings on both a regional and a nationwide basis under the single brand identity;
(c) negotiating discounted prices for the purchase of various goods and services on behalf of the aggregated plurality of independently owned commercial office buildings and a plurality of tenants of each of the member entities;
(d) negotiating one or more revenue sharing opportunities on behalf of the aggregated plurality of independently owned commercial office buildings from vendors seeking to advertise or display products or services on the commercial office building premises, or to gain access to the commercial office building premises to install equipment that may be used in marketing and selling products or services to the tenants of each of the member entities;
(d) implementing an online listing and reservation system to market space available for lease in the aggregated plurality of independently owned commercial office buildings and to facilitate leasing transactions; and
(e) implementing an online e-marketplace transaction platform where a plurality of the member entities can solicit bids for certain goods and services from one or more vendors for use at their commercial office building premises.

2. The process of claim 1 further comprising the step of identifying a potential member entity of the business network through at least one of a referral by an existing member entity, a referral from a third-party vendor and a review of a real estate database including commercial office space listings.

3. The process of claim 2 further comprising the step of meeting with a potential member entity of the business network after the step of identifying the potential member entity of the business network in order to give a presentation concerning the benefits of affiliation with the business network.

4. The process of claim 3 further comprising the step of presenting a participation agreement to the potential member entity for execution by the potential member entity if the potential member entity agrees to become a member of the business network.

5. The process of claim 4 further comprising the step of completing a detailed assessment of the member entity's commercial office buildings.

6. The process as claimed in 5 further comprising the step of assessing the new member entity an annual membership fee based on a total square footage of a commercial office building owned or operated by the new member entity, a percentage of gross revenues derived from the member entity property, or some other metric associated with the commercial office building owned/operated by the new member entity.

7. A process for enrolling a member entity in a business network including a plurality of member entities wherein each member entity owns/operates at least one commercial office building, the process comprising the steps of:
(a) identifying a potential member entity of the business network through at least one of a referral by an existing member entity, a referral from a third-party vendor, a physical inspection of a particular market or submarket to identify one or more qualified commercial office buildings, and a review of a real estate database including a plurality of commercial office space listings;
(b) meeting with the potential member entity of the business network after the step of identifying the potential member entity of the business network in order to give a presentation to the potential member entity concerning the benefits of affiliation with the business network; and
(c) presenting a participation agreement to the potential member entity for execution by the potential member entity if the potential member entity agrees to become a member entity of the business network.

8. The process as claimed in claim 7 wherein following execution of the participation agreement by the potential member entity, the potential member entity becomes a new member entity, and wherein the process further comprises the step of assessing the new member entity an annual membership fee.

9. A process for implementing a purchasing program for a business network including a plurality of member entities wherein each member entity owns/operates at least one commercial office building, the process comprising the steps of:
(a) the business network forming an alliance with each one of a plurality of vendors, including a vendor that facilitates online procurement and bid management of a variety of goods and services, each one of the plurality of vendors offering for purchase goods and/or services required for operation of a commercial office building, wherein each one of the plurality of vendors becomes a preferred vendor of the business network for the particular goods/services offered by the one of the plurality of vendors;
(b) each member entity selecting needed goods/services available for purchase from the plurality of vendors;
(c) each one of the plurality of vendors offering the goods/services available for purchase at discounted prices to the plurality of member entities of the business network; and
(d) each member entity negotiating and forming contracts with each one of the plurality of vendors offering the selected needed goods/services.

10. The process as claimed in claim 9 wherein the goods and/or services include janitorial goods and services, equipment maintenance services, landscaping goods and services, security services, building management services, office supplies, office furniture and travel-related services.

11. The process as claimed in claim 9 wherein each one of the plurality of vendors with whom alliances are formed is selected based upon its reputation for providing high quality goods/services.

12. The process as claimed in claim 9 wherein the step of forming an alliance with each one of a plurality of vendors includes the sub-step of inserting a termination for convenience provision in each alliance agreement with each one of the plurality of vendors permitting the business network to terminate the alliance agreement at any time and for any reason.

13. The process as claimed in claim 12 wherein the step of each member entity negotiating and forming contracts with each one of the plurality of vendors offering the selected needed goods/services includes the sub-steps of:
(a) inserting a termination provision into each one of the contracts wherein the one of the contracts is automatically terminated if the alliance agreement between the one of the vendors and the business network is terminated; and
(b) inserting a termination provision into each one of the contracts wherein the one of the contracts is automatically terminated if the member entity ceases to be a member entity of the business network.

14. The process as claimed in claim 12 wherein the step of forming an alliance agreement with each one of a plurality of vendors includes the sub-step of including a provision in the alliance agreement wherein the one of the vendors agrees to pay the business network an annual marketing fee wherein the annual marketing fee is calculated based upon the annual gross revenues generated in all of the contracts between the one of the vendors and each member entity.

15. The process as claimed in claim 1 wherein the online listing and reservation system is comprised of:
(a) a data source including a listing for each one of the commercial office buildings owned/managed by each one of the member entities wherein the listing includes a location for each one of the commercial office buildings, an age of each one of the commercial office buildings, one or more units of office space available for leasing in each one of the commercial office buildings, a rental price for the one or more units of office space available, a square footage amount for the one or more units of office space available, and one or more amenities associated with the one or more units of office space available;
(b) a search/retrieval engine for querying the data source based upon one or more input parameters and for selectively retrieving at least one listing of one or more units of office space available for leasing corresponding to the input parameters; and
(c) a reservation engine for enabling a prospective tenant to contact a member entity to reserve one or more units of available office space under flexible lease terms including a short term duration lease or the leasing of furnished space.

16. The process as claimed in claim 1 wherein the regional marketing step includes the sub-steps of:
(a) placing advertisements in a plurality of industry publications relating to a plurality of benefits a potential tenant may realize through leasing office space in one of the commercial office buildings of one of the member entities of the business network; and
(b) launching an Internet web site accessible to a plurality of potential tenants having content relating to the plurality of benefits a potential tenant may realize through leasing office space in one of the commercial office buildings of one of the member entities of the business network.
